(19) United States
(12) Patent Application Publication
(10) Pub. No.: US 2007/0038163 A1
(43) Pub. Date: Feb. 15, 2007

(54) Electronic impulse massage apparatus with multiple functions

(75) Inventor: Chin-Chih Hsieh, Taipei (TW)

Correspondence Address: HDSL, 4331 STEVENS BATTLE LANE, FAIRFAX, VA, 22033, US

(73) Assignee: Well-Life Healthcare Inc.

(21) Appl. No.: 11/199,133

(22) Filed: Aug. 9, 2005

(51) Int. Cl. A61H 1/00

(52) U.S. Cl. 601/21; 601/DIG. 3

(57) ABSTRACT

An electronic impulse massage apparatus with multiple functions includes a controller, an operation switch unit, a memory pre-stored with a plurality of operational modes, an output selection unit, a patch connected to the output selection unit and a wire output port connected to the output selection unit. The electronic impulse massage apparatus can be selected to operate at one of a manual mode, an automatic mode and a preferred mode. The operation switch unit further includes keys to fine-tune the impulse voltage level and key to select output port. Therefore, the electronic impulse massage apparatus can provide versatile function and convenience to user.

### BACKGROUND OF THE INVENTION

1. Field of the Invention

The present invention relates to an electronic impulse massage apparatus, especially to an electronic impulse massage apparatus operable with multiple functions and multiple output ports.

2. Description of Prior Art

People become more and more concerned about their appearance as life quality is enhanced. For example, some people will adopt invasion approach such as skin surgeon or botulinus injection for skin enhancement. However, above approaches are dangerous and might have some side effects.

Some users may adopt electronic pulse massage apparatus to contract muscle by stimulus, wherein muscle fiber is strengthened and the skin aging is postponed. The movement of human body is triggered by nerve system and the bone is driven by muscle to control movement of body. The nerve system comprises center nerve system and peripheral nerve system. The message sent by user brain, namely impulses are conveyed through neurons. Moreover particularly, the cell membrane of neuron has voltage of −70 mV at rest and has voltage of +30 mV at exercise. The voltage at the cell membrane of neuron will fall back to −70 mV after exercise.

The conventional impulse massage apparatus applies electronic impulse signals of predetermined waveform to human skin through electrodes. For example, the electrode can be fixed to user skin through the help of patches and the electronic impulse signals of predetermined waveform are impulses with frequency 5-130 Hz and pulse width of 20 μs to 100 μs

However, the conventional impulse massage apparatus can only apply electronic impulse signals of predetermined waveform. This is inconvenient for user desiring to massage different body potion or use different waveform. Therefore, user usually needs to buy different impulse massage apparatus to achieve different effects.

### SUMMARY OF THE INVENTION

The present invention is intended to provide an electronic impulse massage apparatus operable with multiple functions and multiple output ports for the convenience of user.

Accordingly, the present invention provides an electronic impulse massage apparatus with multiple functions, which comprises a microprocessor; at least operation switch electrically connected to the microprocessor; a memory electrically connected to the microprocessor and pre-stored with a plurality of operation modes; a pulse generator electrically connected to the microprocessor and generating electronic impulse under the control of the microprocessor; an output selection switch electrically connected to the pulse generator; a patch electrically connected to the output selection switch; at least one wire output electrically connected to the output selection switch.

The microprocessor determines an operation mode and an output path according to an input of the at least operation switch. The at least operation switch comprises an output mode selection button to select one of the pre-stored operation modes, a turn off/level down button for turn off/level down operation, a turn on/level up button for turn on/level up operation, and an output selection button to control the output path of the output selection switch.

The electronic impulse massage apparatus further comprises a display unit electrically connected to the microprocessor and the display unit comprises an LCD and a set of LED lamps to manifest the operation mode, the remaining time and the intensity level.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1A shows a top view of the electronic impulse massage apparatus with multiple functions according to a preferred embodiment of the present invention.

FIG. 1B shows a bottom view of the electronic impulse massage apparatus with multiple functions according to a preferred embodiment of the present invention.

FIG. 2 shows a block diagram of the electronic impulse massage apparatus according to a preferred embodiment of the present invention.

FIG. 3 shows a control flowchart of the electronic impulse massage apparatus according to a preferred embodiment of the present invention.

FIG. 4 shows an application of the electronic impulse massage apparatus according to a preferred embodiment of the present invention.

### DETAILED DESCRIPTION OF THE INVENTION

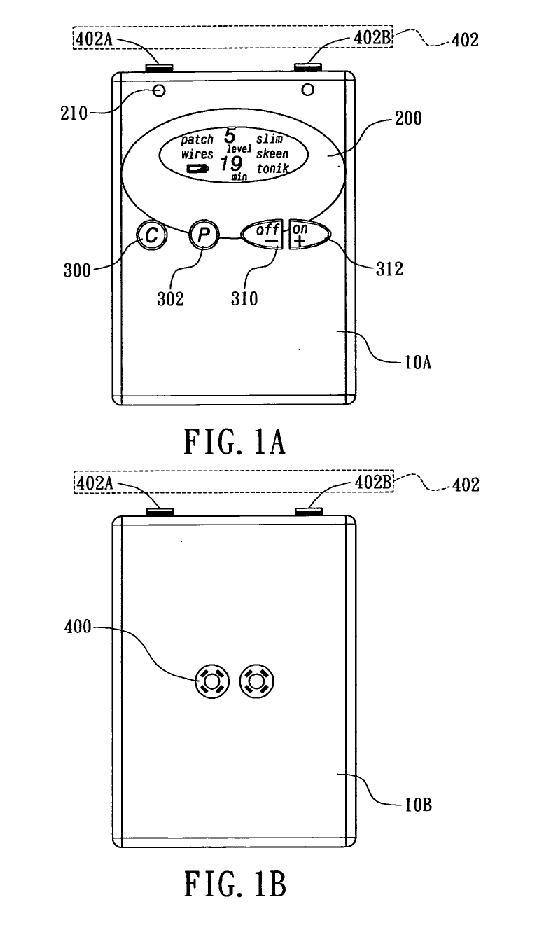

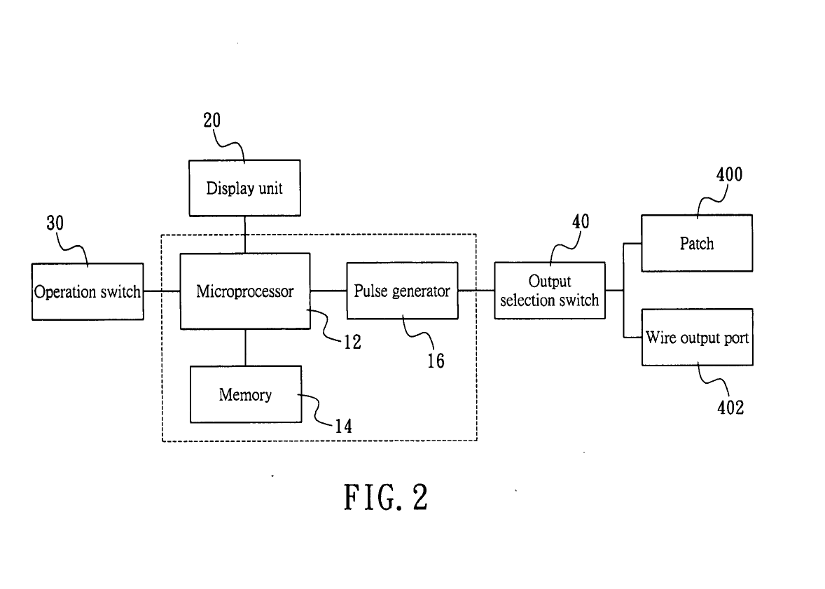

With reference to FIGS. 1A and 1B, the electronic impulse massage apparatus 10 with multiple functions according to the present invention comprises a display unit 20 on an upper casing 10A, operation switches 30, at least one wire output port 402 (including a first wire output port 402A and a second wire output port 402B) and a patch 400 on a lower casing 10B, Moreover, the electronic impulse massage apparatus 10 further comprises control circuit (not shown) within casing and this will be stated in more dental later with reference to FIG. 2.

The display unit 20 comprises, for example, an LCD 200 and a set of LED lamps 210. The LCD 200 displays the information of the electronic impulse massage apparatus 10, such as output port, remaining battery amount, intensity level, set time and operation mode etc. For example, as shown in FIG. 1A, when a “Patch” portion on left side of the LCD 200 is lighted, it means the output of the electronic impulse massage apparatus 10 is sent through the patch 400. Moreover, when a “Wires” portion on left side of the LCD 200 is lighted, it means the output of the electronic impulse massage apparatus 10 is sent through the first wire output port 402A (Channel 1) and the second wire output port 402B (Channel 2). Moreover, when the “Patch” portion and the “Wires” portion on left side of the LCD 200 are lighted, it means the outputs of the electronic impulse massage apparatus 10 are sent through the patch 400 and the output ports 402A and 402B. The outputs of the electronic impulse massage apparatus 10 sent through the patch 400 and the output ports 402A and 402B may be electronic impulse of different intensity levels.

A bar-like portion on left side of the LCD 200 indicates a remaining battery amount and a center portion of the LCD 200 indicates intensity level and set time. With reference to FIG. 1A, the LCD 200 shows the electronic impulse massage apparatus 10 being operated at Level 5 intensity and the remaining time is 19 minutes. A right portion of the LCD 200 shows the operation modes of the electronic impulse massage apparatus 10. The operation modes of the electronic impulse massage apparatus 10, for example, can be to reduce weight, abstain from smoking, reduce pressure, remove wrinkle and prevent muscle pain. The operation modes of the electronic impulse massage apparatus 10 can also be represented by some symbols. For example, the operation modes of the electronic impulse massage apparatus 10 are represented by SLIM, SKEEN, TONIK symbols as shown in FIG. 1A.

The LED lamps 210 indicate output status of the first wire output port 402A (Channel 1) and the second wire output port 402B (Channel 2). When electronic impulse are output through the first wire output port 402A (Channel 1) and the second wire output port 402B (Channel 2), the LED lamps 210 are lighted to remind user.

The operation switches 30, for example, comprise an output selection button 300, an output mode selection button 302, a turn off/level down button 310 and a turn on/level up button 312. The output selection button 300 is operated to select at least one of the patch 400, the output ports 402A and 402B for outputting electronic impulse. The output mode selection button 302 is operated to select at least one of the SLIM, SKEEN, TONIK operation modes.

When the electronic impulse massage apparatus 10 is already turned on, the electronic impulse massage apparatus 10 can be turned off after the turn off/level down button 310 is pressed more than a predetermined time (for example, 2 seconds). When the electronic impulse massage apparatus 10 is already turned off, the electronic impulse massage apparatus 10 can be turned on after the turn on/level up button 312 is pressed more than a predetermined time (for example, 2 seconds).

FIG. 2 shows a block diagram of the electronic impulse massage apparatus 10 according to a preferred embodiment of the present invention. The electronic impulse massage apparatus 10 mainly comprises a controller consisting of a microprocessor 12, a memory 14, and a pulse generator 16. The controller is electrically connected to the display unit 20 and the operation switches 30 to display operation information like output path, operation intensity level, and operation modes on the display unit 20 according to user input. Moreover, the controller of the electronic impulse massage apparatus 10 can selectively send the output of the pulse generator 16 to at least one of the patch 400 and the output ports 402A and 402B through an output selection switch 40.

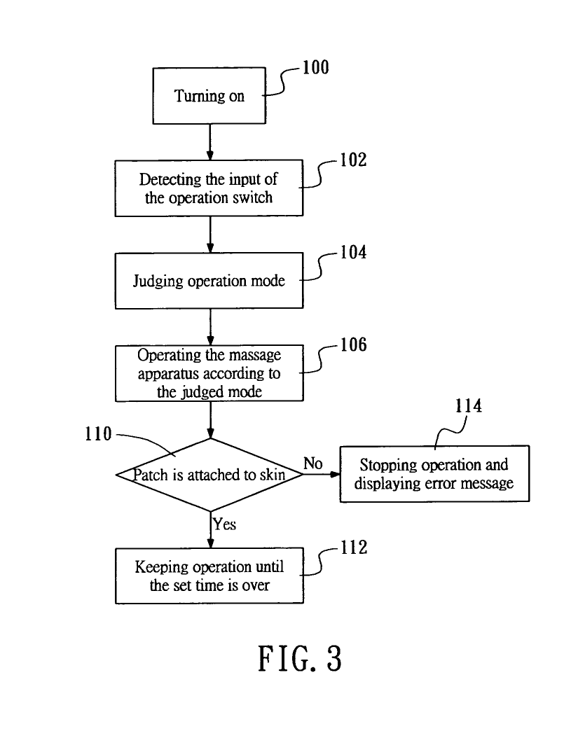

FIG. 3 shows a control flowchart of the electronic impulse massage apparatus 10 according to a preferred embodiment of the present invention. The control flowchart can be performed by the microprocessor 12 to output user desired operation mode and output path according to the input of the operation switches 30 and pre-stored data in the memory 14. After the electronic impulse massage apparatus 10 is turned on (step 100), the microprocessor 12 detects at least one input through the operation switches 30 (step 102) and judges the operation modes (step 104). A specific operation mode is performed after the operation mode is decided (step 106). The microprocessor 12 keeps monitoring whether the patch is attached on user skin (step 110). If true, the operation continues until the set time is over (step 112), else the output is stopped and an error message is displayed (step 114).

In above operation flow, the user can select operation modes by the operation switches 30. For example, the electronic impulse massage apparatus 10 can be operated at one of a manual mode, an automatic mode or a preferred mode. The electronic impulse massage apparatus 10 can be operated at the automatic mode if the turn on/level up button 312 is pressed more than 2 seconds when the electronic impulse massage apparatus 10 is turned off. For example, the electronic impulse massage apparatus 10 can be automatically operated at SLIM mode and the intensity level is increased slowly from level 0 to level 3 (provided there is 10 levels). Afterward, the user can use the turn off/level down button 310 or the turn on/level up button 312 to decrease or increase intensity level.

During turning off condition, the electronic impulse massage apparatus 10 is turned on with manual mode if the user presses the output mode selection button 302. At this time, the feasible modes such as SLIM, SKEEN, TONIK are blinked. The user can press the output mode selection button 302 again to select one of the SLIM, SKEEN, TONIK modes, and uses the output selection button 300 to select at least one of the patch 400 and the output ports 402A and 402B for outputting electronic impulse. Similarly, the user can use the turn off/level down button 310 or the turn on/level up button 312 to decrease or increase intensity level.

After one massage session is over and while the electronic impulse massage apparatus 10 is still turned on, the user can press the turn on/level up button 312 again to operate the electronic impulse massage apparatus 10 in a preferred mode, for example, the SLIM mode. Similarly, the user can use the turn off/level down button 310 or the turn on/level up button 312 to decrease or increase intensity level.

In above description, the SLIM, SKEEN, TONIK modes have different impulse intensity, waveform and frequency and those parameters can be pre-stored in the memory 14 to achieve the effects of reducing weight, abstaining from smoking, reducing pressure, removing wrinkle and preventing muscle pain.

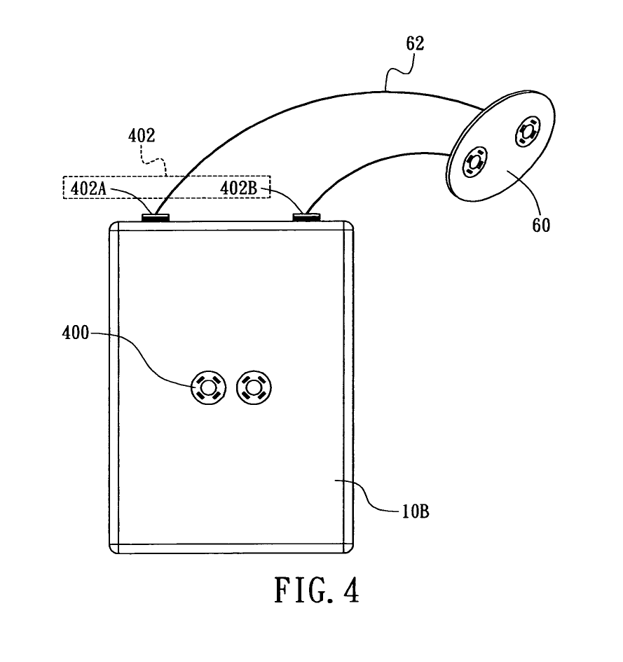

FIG. 4 shows an application of the electronic impulse massage apparatus 10 according to a preferred embodiment of the present invention. The electronic impulse massage apparatus 10 outputs an electronic impulse of predetermined mode, intensity level and set time through the patch 40, and outputs another electronic impulse of another predetermined mode, intensity level and set time through the output ports 402A and 402B. The output ports 402A and 402B are electrically connected to another patch 60 through conductive wires 62 to stimulate different skin portions. For example, when the electronic impulse massage apparatus 10 is fixed to cheek of user and the other patch 60 can be fixed to other facial portion such as forehead. The cheek of user and the forehead of user can be simultaneously massaged with electronic impulses of different modes, intensity levels and set times. The electronic impulses of different modes, intensity levels and set times can be output through the patch 40, and the output ports 402A and 402B to achieve different effects.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. An electronic impulse massage apparatus with multiple functions, comprising:
a microprocessor;
at least operation switch electrically connected to the microprocessor;
a memory electrically connected to the microprocessor and pre-stored with a plurality of operation modes;
a pulse generator electrically connected to the microprocessor and generating electronic impulse under the control of the microprocessor; and
a patch electrically connected to the pulse generator for outputting the electronic impulse, wherein the microprocessor determines an operation mode according to an input of the at least operation switch.

2. The electronic impulse massage apparatus as in claim 1, wherein the at least operation switch comprises an output mode selection button to select one of the pre-stored operation modes.

3. The electronic impulse massage apparatus as in claim 2, wherein the at least operation switch further comprises a turn off/level down button for turn off/level down operation, and a turn on/level up button for turn on/level up operation.

4. The electronic impulse massage apparatus as in claim 1, further comprising an output selection switch electrically connected to the pulse generator and the patch and a wire output port electrically connected to the output selection switch, wherein the output selection switch selectively sends the electronic impulse to at least one of the patch and the wire output port.

5. The electronic impulse massage apparatus as in claim 4, wherein the at least operation switch further comprises an output selection button to control an output path of the output selection switch.

6. The electronic impulse massage apparatus as in claim 1, further comprising a display unit electrically connected to the microprocessor.

7. The electronic impulse massage apparatus as in claim 6, wherein the display unit comprises an LCD and a set of LED lamps.

8. The electronic impulse massage apparatus as in claim 7, wherein the LCD displays the operation mode.

9. The electronic impulse massage apparatus as in claim 7, wherein the LCD displays an output path.

10. The electronic impulse massage apparatus as in claim 7, wherein the LCD displays a remaining battery amount.

11. The electronic impulse massage apparatus as in claim 7, wherein the LCD displays an electronic impulse intensity level.

12. The electronic impulse massage apparatus as in claim 7, wherein the LCD displays a remaining operation time.

13. The electronic impulse massage apparatus as in claim 1, wherein the patch detects an un-attached state of the patch.

14. The electronic impulse massage apparatus as in claim 13, wherein the microprocessor stops the output of the electronic impulse when the patch is in the un-attached state.

15. The electronic impulse massage apparatus as in claim 4, wherein the wire output port detects an un-attached state of a patch thereof.

16. The electronic impulse massage apparatus as in claim 15, wherein the microprocessor stops the output of the electronic impulse when the patch is in the un-attached state.

17. An electronic impulse massage apparatus with multiple functions, comprising:
a microprocessor;
at least operation switch electrically connected to the microprocessor;
a memory electrically connected to the microprocessor and pre-stored with a plurality of operation modes;
a pulse generator electrically connected to the microprocessor and generating electronic impulse under the control of the microprocessor;
an output selection switch electrically connected to the pulse generator;
a patch electrically connected to the output selection switch;
at least one wire output electrically connected to the output selection switch;
wherein the microprocessor determines an operation mode and an output path according to an input of the at least operation switch.

18. The electronic impulse massage apparatus as in claim 17, wherein the at least operation switch comprises an output mode selection button to select one of the pre-stored operation modes.

19. The electronic impulse massage apparatus as in claim 17, wherein the at least operation switch further comprises a turn off/level down button for turn off/level down operation, and a turn on/level up button for turn on/level up operation.

20. The electronic impulse massage apparatus as in claim 17, wherein the at least operation switch further comprises an output selection button to control the output path of the output selection switch.

21. The electronic impulse massage apparatus as in claim 17, further comprising a display unit electrically connected to the microprocessor.

22. The electronic impulse massage apparatus as in claim 21, wherein the display unit comprises an LCD and a set of LED lamps.
